(19) United States
(12) Patent Application Publication
(10) Pub. No.: US 2024/0023751 A1
(43) Pub. Date: Jan. 25, 2024

(54) INFORMATION PROCESSING METHOD, INFORMATION PROCESSING DEVICE, AND NON-TRANSITORY COMPUTER READABLE STORAGE MEDIUM

(71) Applicant: Panasonic Intellectual Property Corporation of America, Torrance, CA (US)

(72) Inventors: Yuki TAKAOKA, Osaka (JP); Kenta MURAKAMI, Osaka (JP); Satoshi SUEMASU, Osaka (JP)

(73) Assignee: Panasonic Intellectual Property Corporation of America, Torrance, CA (US)

(21) Appl. No.: 18/376,580

(22) Filed: Oct. 4, 2023

Related U.S. Application Data
(63) Continuation of application No. PCT/JP2022/003763, filed on Feb. 1, 2022.

(30) Foreign Application Priority Data
Apr. 6, 2021 (JP) 2021-064765

(51) Int. Cl. A47J 36/32; A47J 27/00

(52) U.S. Cl. CPC A47J 36/321; A47J 27/004

(57) ABSTRACT

Provided is an information processing method including: by a computer, acquiring information indicating a first recipe including multiple cooking processes and multiple blocks associated with the corresponding multiple cooking processes, the multiple blocks including first information indicating at least one of an apparatus and an instrument used in the multiple cooking processes; acquiring second information indicating one or more apparatuses and instruments possessed by a user and information indicating operation states of the one or more apparatuses and instruments indicated by the second information; generating a second recipe by deleting, from the first recipe, a block including one or more apparatuses and instruments that are included in the first information and are not included in the second information, and a block including one or more apparatuses and instruments having an operation state indicating being in operation; and outputting information indicating the second recipe to be displayed on a display.

### FIELD OF INVENTION

The present disclosure relates to a technique for displaying a recipe using multiple apparatuses and instruments.

### BACKGROUND ART

Household electrical appliances, household facilities, and the like are conventionally controlled in accordance with operation conditions (control programs) prepared in advance by manufacturers and the like thereof. Patent Literature 1 discloses a washing machine capable of setting an operation condition of washing desired by a user.

Unfortunately, the conventional technique described above requires a control program developed in advance by a manufacturer or the like of a product to be stored in advance in the product, so that a diverse and safe control program for the product is less likely to be generated, and customized and updated. The control program is not considered to be customized in consideration of an apparatus and an instrument possessed by the user.

Thus, when cooking according to the recipe, the user needs to customize a recipe by selecting an apparatus and an instrument suitable for each cooking process and changing setting of the apparatus, for example, in consideration of a difference in an apparatus and an instrument between those indicated in the recipe and those possessed by the user.
Patent Literature 1: JP 2003-284889 A

### SUMMARY OF THE INVENTION

The present disclosure has been made to solve the above problems, and an object thereof is to present an information processing method, an information processing device, and a program, capable of easily customizing a recipe in accordance with an apparatus and an instrument possessed by a user.

An information processing method according to an aspect of the present disclosure includes: by a computer, acquiring information indicating a first recipe including multiple cooking processes and multiple blocks associated with the corresponding multiple cooking processes, the multiple blocks including first information indicating at least one of an apparatus and an instrument used in the multiple cooking processes; acquiring second information indicating one or more apparatuses and instruments possessed by a user and information indicating operation states of the one or more apparatuses and instruments indicated by the second information; generating a second recipe by deleting, from the first recipe, a block including one or more apparatuses and instruments that are included in the first information and are not included in the second information, and a block including one or more apparatuses and instruments having an operation state indicating being in operation; and outputting information indicating the second recipe to be displayed on a display.

### BRIEF DESCRIPTION OF THE DRAWINGS

FIG. 1 is a block diagram illustrating an example of a general configuration of a recipe providing system.

FIG. 2 is a block diagram illustrating an example of a functional configuration of a development terminal.

FIG. 3 is a diagram illustrating an example of a recipe creation screen.

FIG. 4 is a block diagram illustrating an example of a functional configuration of a user terminal.

FIG. 5 is a diagram illustrating an example of a recipe reference screen.

FIG. 6 is a diagram illustrating an example of generating a user recipe.

FIG. 7 is a diagram illustrating an example of a method for determining a first block according to a washing item reduction rule.

FIG. 8 is a diagram illustrating an example of a method for determining a first block according to a time reduction rule.

FIG. 9 is a diagram illustrating an example of a method for determining a first block according to a labor saving rule.

FIG. 10 is a diagram illustrating a display example of a recommended recipe created when a first block is determined by a labor saving rule.

FIG. 11 is a diagram illustrating a display example of multiple recommended recipes created when a first block is determined by an automatic rule.

FIG. 12 is a flowchart illustrating an example of a method for registering a block.

FIG. 13 is a flowchart illustrating an example of processing of creating a recipe.

FIG. 14 is a flowchart illustrating an example of processing of displaying a user recipe.

FIG. 15 is a flowchart illustrating an example of processing of displaying a recommended recipe.

FIG. 16 is a flowchart illustrating an example of processing of creating a recommended recipe.

FIG. 17 is a flowchart illustrating an example of processing of creating a recommended recipe according to an automatic rule.

### DETAILED DESCRIPTION

(Background to the Present Disclosure)

In recent years, demand for an application for coordinating multiple apparatuses in home has increased. Examples of the application include an application that operates multiple apparatuses, such as a rice cooker, a microwave oven, and an induction heating (IH) cooking heater, according to a recipe.

Unfortunately, control programs of the apparatuses are developed in advance by a manufacturer or the like, being familiar with the apparatuses, as described above, so that a person who is not familiar with the apparatuses cannot easily customize and update the control programs. Thus, a development tool has been proposed in recent years, the development tool enabling easy creation of an application that controls multiple products by disposing blocks representing abstracted operation of respective apparatuses in time series.

It is assumed that an application that controls multiple apparatuses according to a recipe as described above is created using a development tool as described above. In this case, a creator of the recipe creates an application of the recipe by defining an example of an apparatus to be used in each cooking process and an instrument to be used in the apparatus because the creator cannot consider an apparatus and an instrument possessed by the user.

However, the user cannot execute the application as it is when the user does not possess an apparatus or an instrument that is assumed to be used in the application of the recipe. In this case, the user needs to customize the recipe by selecting an apparatus and an instrument suitable for each cooking process and changing setting of the apparatus, for example, in consideration of a difference in an apparatus and an instrument between those assumed to be used in the application and those possessed by the user.

For this reason, the present inventors have intensively studied a technique capable of easily customizing a recipe in accordance with an apparatus and an instrument possessed by a user, and have conceived each aspect of the present disclosure described below.

An information processing method according to an aspect of the present disclosure includes: by a computer, acquiring information indicating a first recipe including multiple cooking processes and multiple blocks associated with the corresponding multiple cooking processes, the multiple blocks including first information indicating at least one of an apparatus and an instrument used in the multiple cooking processes; acquiring second information indicating one or more apparatuses and instruments possessed by a user and information indicating operation states of the one or more apparatuses and instruments indicated by the second information; generating a second recipe by deleting, from the first recipe, a block including one or more apparatuses and instruments that are included in the first information and are not included in the second information, and a block including one or more apparatuses and instruments having an operation state indicating being in operation; and outputting information indicating the second recipe to be displayed on a display.

With this configuration, the second recipe is generated by deleting, from the first recipe, the block including one or more apparatuses and instruments that are not possessed by the user, and a block including the apparatus and instrument in operation, and the information indicating the second recipe to be displayed on the display is output. Thus, the user can grasp a recipe including a cooking process associated with the block including the apparatus and instrument that can be used by the user by displaying the second recipe on the display. As a result, the user can easily customize the first recipe in accordance with the apparatus and instrument used by the user only by selecting one block from among one or more blocks associated with corresponding cooking processes included in the second recipe.

The information processing method described above may include: determining a first block from among multiple blocks associated with the first cooking process, according to one or more rules, when a first cooking process associated with multiple blocks is detected from the second recipe; creating one or more third recipes according to the one or more rules by associating the first block with the first cooking process in the second recipe; and outputting information indicating the one or more third recipes to be displayed on the display.

With this configuration, the user can display one or more third recipes according to one or more rules on the display, and easily refer to the third recipes corresponding to the respective rules.

The method for processing information described above may be configured such that the one or more rules include a first rule, and the first rule is defined to determine a block as the first block from among the multiple blocks associated with the first cooking process when a second cooking process associated with only one block is detected from the second recipe, the block including an apparatus included in the one block.

The present configuration enables reduction in number of apparatuses to be used and eventual reduction in number of washing items by displaying a third recipe on the display, the third recipe including a block that includes an apparatus included in the one block associated with the second cooking process and that is associated with the first cooking process, and allowing the user to perform cooking according to the third recipe.

The information processing method described above may be configured such that the respective blocks further include cooking times required for a cooking process, the one or more rules include a second rule, and the second rule is defined to determine a block as the first block from among the multiple blocks associated with the first cooking process, the block including a shortest time among the cooking times.

The present configuration enables reduction in time required for cooking by displaying the third recipe with the block that includes the shortest cooking time and that is associated with the first cooking process on the display to allow the user to perform cooking according to the third recipe.

The information processing method described above may be configured such that the respective blocks further include intervention degrees as degrees of involvement of a person in each cooking process, the one or more rules include a third rule, and the third rule is defined to determine a block as the first block from among the multiple blocks associated with the first cooking process, the block including a lowest degree among the intervention degrees.

The present configuration enables reduction in labor required for cooking by displaying the third recipe with the block that includes the lowest intervention degree and that is associated with the first cooking process on the display to allow the user to perform cooking according to the third recipe.

The information processing method described above may be configured such that the one or more rules are multiple rules, input of one rule selected from the multiple rules by a user is received, and one third recipe according to the one rule is created using the first block determined according to the one rule.

The present configuration enables the user to easily use the third recipe according to a desired rule by outputting one third recipe according to one rule selected to the display.

An information processing device according to another aspect of the present disclosure includes: a first acquisition unit that acquires information indicating a first recipe including multiple cooking processes and multiple blocks associated with the corresponding multiple cooking processes, the multiple blocks including first information indicating at least one of an apparatus and an instrument used in the multiple cooking processes; a second acquisition unit that acquires second information indicating one or more apparatuses and instruments possessed by a user and information indicating operation states of the one or more apparatuses and instruments indicated by the second information; a generator that generates a second recipe by deleting, from the first recipe, a block including one or more apparatuses and instruments that are included in the first information and are not included in the second information, and a block including one or more apparatuses and instruments having an operation state indicating being in operation; and an output unit that outputs information indicating the second recipe to be displayed on a display.

The present configuration enables acquiring effects similar to those of the information processing method described above.

A non-transitory computer readable storage medium according to yet another aspect of the present disclosure is a non-transitory computer readable storage medium storing a program that causes a computer to function, the computer functioning as: a first acquisition unit that acquires information indicating a first recipe including multiple cooking processes and multiple blocks associated with the corresponding multiple cooking processes, the multiple blocks including first information indicating at least one of an apparatus and an instrument used in the multiple cooking processes; a second acquisition unit that acquires second information indicating one or more apparatuses and instruments possessed by a user and information indicating operation states of the one or more apparatuses and instruments indicated by the second information; a generator that generates a second recipe by deleting, from the first recipe, a block including one or more apparatuses and instruments that are included in the first information and are not included in the second information, and a block including one or more apparatuses and instruments having an operation state indicating being in operation; and an output unit that outputs information indicating the second recipe to be displayed on a display.

The present configuration enables acquiring effects similar to those of the information processing method described above.

The present disclosure can also be implemented as a system that operates by a program as described above. It is needless to say that such a computer program can be distributed using a computer-readable non-transitory recording medium such as a CD-ROM, or via a communication network such as the Internet.

Each of embodiments described below illustrates a specific example of the present disclosure. Numerical values, shapes, components, steps, order of steps, and the like shown in the embodiments below are merely examples, and are not intended to limit the present disclosure. The components in the embodiments below includes a component that is not described in independent claims indicating the highest concept, and then the component is described as an optional component. In all the embodiments, respective contents can be combined.

### First Embodiment

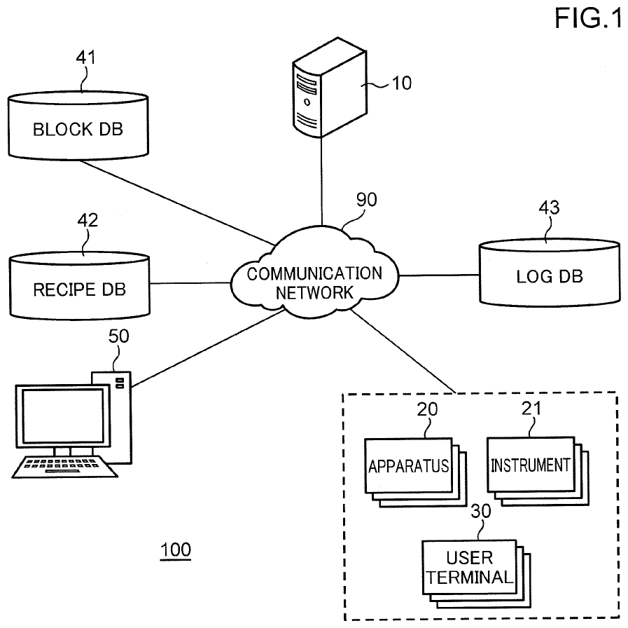

Hereinafter, embodiments of the present disclosure will be described with reference to the drawings. FIG. 1 is a diagram illustrating an example of a general configuration of a recipe providing system 100. The recipe providing system 100 provides recipe information indicating a recipe created by a development terminal 50 to a user terminal 30 (information processing device) via a communication network 90.

Specifically, as illustrated in FIG. 1, the recipe providing system 100 includes one or more apparatuses 20 and instruments 21 possessed by a user, a block database 41, a recipe database 42, a log database 43, the development terminal 50, multiple user terminals 30, and an application providing server 10. For example, these components provided in the recipe providing system 100 are connected via the communication network 90 such as the Internet.

Examples of the apparatuses 20 include one or more electric appliances for cooking possessed by the user, such as a rice cooker, an IH cooking heater, a multi-cooker, a cutting board with a scaler (hereinafter simply referred to as a cutting board), a microwave oven, and an oven range. Each apparatus 20 transmits log information indicating its own operation state to the application providing server 10 via the communication network 90. The log information includes current date and time, identification information on each apparatus 20, information indicating whether each apparatus 20 is in operation, information indicating contents of operation when each apparatus 20 is in operation, a start time of the operation, information indicating whether abnormality occurs during the operation, and the like.

The instruments 21 are each a container or a tool used for cooking ingredients with the corresponding apparatuses 20. Examples of the instruments 21 include containers such as a frying pan, a pot, a ball, a bat, and a heat-resistant dish. The examples of the instruments 21 also include a tool used by the user to perform preliminary preparation such as cutting an ingredient to be cooked before cooking by the corresponding apparatuses 20, such as a kitchen knife, a cooking scissors, a tongue, and a peeler.

The block database 41 includes storage devices such as a hard disk drive (HDD) and a solid state drive (SSD). The block database 41 stores multiple blocks created by a developer of each apparatus 20.

Each block indicates information including operation of the corresponding one of the apparatuses 20. For example, each block may indicate information indicating the operation itself of the corresponding one of the apparatuses 20, or may indicate information indicating abstracted operation of the corresponding one of the apparatuses 20. Each block is formed as a screen component usable in the development terminal 50 and the user terminal 30. Each block is created by a developer familiar with the corresponding one of the apparatuses 20. Each block is configured to have a settable parameter related to the operation of the corresponding one of the apparatuses 20 included in the block. The parameter related to the operation of the apparatus 20 may include the corresponding instruments 21 used in the operation of the apparatus 20. The operation of the apparatus 20 included in the block and the information indicating the instrument 21 that can be included in the block indicate an example of the first information according to the present disclosure.

Examples of a block of the oven range include a block including a baking operation of the oven range and a block including a steaming operation of the oven range. Hereinafter, a block including operation of “X” of an apparatus 20 is referred to as a block “X” of the apparatus 20. Examples of a parameter settable in a block “baking” of the oven range include a set temperature in the oven range, a time required for the inside of the oven range to reach the set temperature, a time for which baking operation of the oven range is continued (referred below as a cooking time), and an instrument 21 used in the baking operation of the oven range.

Each block may also indicate information including operation of the corresponding instruments 21. For example, each block may indicate information indicating the operation itself of the corresponding one of the instruments 21, or may indicate information indicating abstracted operation of the corresponding one of the instruments 21. The block is created by a developer familiar with the instrument 21. The operation of the instrument 21 indicates operation performed by the user using the instrument 21. Examples of operation of the kitchen knife include cutting an ingredient, crushing an ingredient, and the like. That is, the block includes information (first information) indicating operation of at least one of the apparatus 20 and the instrument 21 used in a cooking process.

Each block also has an intervention degree indicating a degree of involvement of a person in the operation of the apparatus 20 or the instrument 21 included in the block. The intervention degree of each block is determined based on a degree of necessity of vision, hearing, or smell of the user for the operation of the apparatus 20 or the instrument 21 included in the block, for example. Besides this, the intervention degree of each block may be determined based on a degree of necessity of manual work of the user for the operation of the apparatus 20 or the instrument 21 indicated by the block. The intervention degree of each block also may be determined based on a frequency of necessity of vision, hearing, or smell of the user or a frequency of necessity of manual work of the user for the operation of the apparatus 20 or the instrument 21 included in the block.

For example, a block including an operation that does not require involvement of the user at all, such as each operation of the multi-cooker, has an intervention degree defined as 0. When operation of boiling is performed with the IH cooking heater, it is considered that the user is required to periodically monitor a state of the boiling using vision, hearing, or smell. A block including an operation that periodically requires vision, hearing, or smell of the user as described above has an intervention degree defined as 1.

When operation of warming is performed with the IH cooking heater, it is considered that the user is required to periodically perform work of stirring. A block including an operation that periodically requires manual work of the user as described above has an intervention degree defined as 2.

When operation of frying is performed with the IH cooking heater, it is considered that the user is required to always check whether ingredients are cooked in a desired state using vision, hearing, or smell. A block including an operation that always requires vision, hearing, or smell of the user as described above has an intervention degree defined as 3. When operation of weighing is performed with the scaler, the user is required to place an object to be weighed on the scaler and to check a weighing result. A block including an operation that always requires manual work of the user as described above has an intervention degree defined as 3. Operation of each instrument 21 always requires manual work by the user, so that a block including the operation of the instrument 21 has an intervention degree defined as 3.

The method for defining an intervention degree is not limited to the above example. For example, the intervention degree may be defined in percentage (percent) by defining the intervention degree of a block including operation that always requires manual work of the user as 100%, and defining the intervention degree of a block including operation that can be automatically performed without involvement of the user as 0%.

The recipe database 42 includes storage devices such as an HDD and an SSD. The recipe database 42 stores recipe information indicating a recipe created in the development terminal 50.

The log database 43 includes storage devices such as an HDD and an SSD. The log database 43 stores log information transmitted from each apparatus 20. The log database 43 also stores apparatus information (second information) indicating at least one of one or more apparatuses and instruments 21 possessed by the user.

The development terminal 50 includes a computer such as a laptop computer, a smartphone, or a tablet terminal, including a processor, a memory, and the like. The development terminal 50 acquires multiple blocks stored in the block database 41 via the communication network 90, and creates a recipe using the multiple acquired blocks.

The user terminal 30 includes a computer such as a notebook computer, a smartphone, or a tablet terminal, including a processor, a memory, and the like. The user terminal 30 requests the application providing server 10 to provide recipe information indicating a recipe created by the development terminal 50 stored in the recipe database 42 via the communication network 90. The user terminal 30 acquires the recipe information transmitted by the application providing server 10 in response to the request via the communication network 90.

The user terminal 30 also requests the application providing server 10 via the communication network 90 to store apparatus information in the log database 43, the apparatus information indicating each apparatus 20 and each instrument 21 possessed by the user, and being input by the user at the time of purchase of the apparatus 20 and the instrument 21, for example. The user terminal 30 further requests the application providing server 10 via the communication network 90 to transmit user apparatus information stored in the log database 43. The user terminal acquires the user apparatus information transmitted by the application providing server 10 in response to the request via the communication network 90.

The application providing server 10 includes a computer such as a server or a cloud server, including a processor, a memory, and the like. The application providing server 10 acquires recipe information indicating a recipe created in the development terminal 50 via the communication network 90, and stores the acquired recipe information in the recipe database 42.

The application providing server 10 acquires the recipe information stored in the recipe database 42 in response to a request for providing a recipe acquired from the user terminal 30 via the communication network 90, and transmits the acquired recipe information to the user terminal 30.

The application providing server 10 stores the acquired user apparatus information in the log database 43 in response to a request for storing the user apparatus information in the log database 43, the request being acquired from the user terminal 30 via the communication network 90.

It is assumed that the user mails the user apparatus information to a provider of the recipe providing system 100. In this case, the application providing server 10 stores the received user apparatus information in the log database 43 via the communication network 90 in response to input operation of the user apparatus information with an operator.

The application providing server 10 acquires the log information from each apparatus 20 via the communication network 90, and stores the acquired log information in the log database 43.

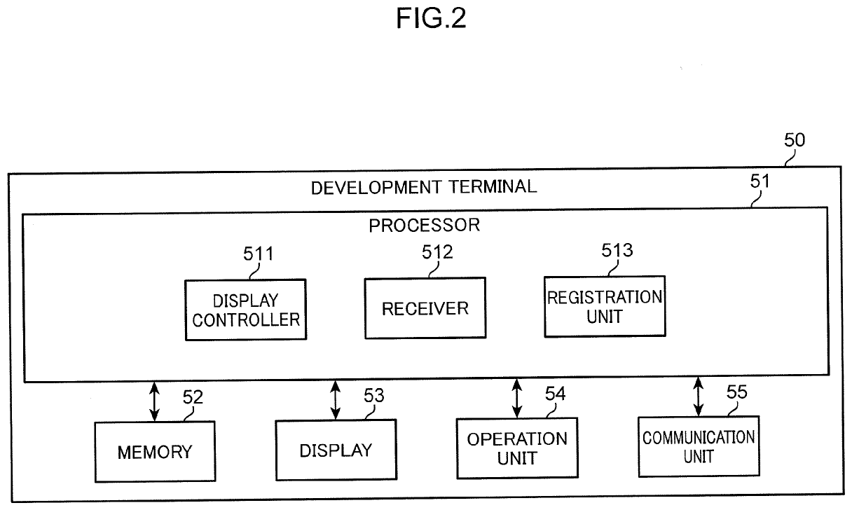

Next, details of the development terminal 50 will be described. FIG. 2 is a block diagram illustrating an example of a functional configuration of the development terminal 50. As illustrated in FIG. 2, the development terminal 50 includes a processor 51, a memory 52, a display 53, an operation unit 54, and a communication unit 55. The processor 51 includes a central processing unit (CPU), for example.

The processor 51 includes a display controller 511, a receiver 512, and a registration unit 513. The display controller 511 to the registration unit 513 are implemented when the processor 51 executes a recipe creation program (program), for example.

The memory 52 includes a nonvolatile memory such as a read only memory (ROM) and a volatile memory such as a random access memory (RAM), and stores various types of information used by the processor 51 for control.

The display 53 includes a liquid crystal display, an organic EL display, or the like, and displays various types of information instructed from the processor 51.

The operation unit 54 includes a touch panel or the like, and is used for various operations of the development terminal 50 with the user. The communication unit 55 includes a communication circuit compatible with an appropriate communication method such as Ethernet (registered trademark), and communicates with an external device via the communication network 90 (FIG. 1).

Next, details of the display controller 511 to the registration unit 513 will be described.

The display controller 511 displays a recipe creation screen W1, which is an operation screen for creating a recipe, on the display 53.

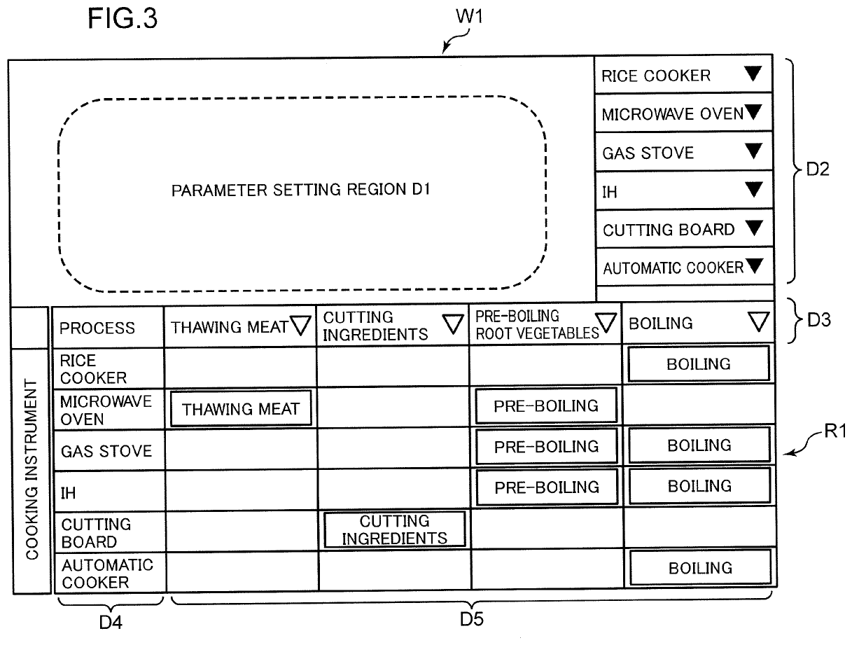

FIG. 3 is a diagram illustrating an example of the recipe creation screen W1. Specifically, when a creator performs a predetermined operation using the operation unit 54, the display controller 511 displays the recipe creation screen W1 as illustrated in FIG. 3. The recipe creation screen W1 includes a block list region D2, a parameter setting region D1, a cooking process setting region D3, a selected block region D5, and an apparatus display region D4.

The block list region D2 allows one or more list boxes for selecting a block associated with each apparatus 20 to be displayed. The parameter setting region D1 allows a parameter setting screen for setting parameters of blocks disposed in the selected block region D5 described later to be displayed. The cooking process setting region D3 allows one or more combo boxes for selecting or editing cooking processes constituting a recipe to be displayed. The selected block region D5 allow a block selected using a list box displayed in the block list region D2 to be disposed. The apparatus display region D4 allows the apparatuses 20 associated with the respective blocks disposed in the selected block region D5 to be displayed. The apparatus 20 associated with the block indicates the apparatus 20 that performs operation of the apparatus 20 included in the block.

For example, FIG. 3 illustrates an example of the recipe creation screen W1, in which a recipe is created, the recipe including four cooking processes of thawing meat, cutting ingredients, pre-boiling root vegetables, and boiling. In the following description, a cooking process of performing X is referred to as a cooking process “X”.

The example of FIG. 3 shows that a block “thawing meat” of the microwave oven selected using the list box displayed in the block list region D2 is disposed in a region below a cooking process “thawing meat” in the selected block region D5. Thus, the microwave oven of the apparatus 20 associated with the block is displayed in a region left to the block in the apparatus display region D4.

FIG. 3 illustrates an example of the selected block region D5, in which three blocks, i.e., a block “pre-boiling” of the microwave oven, a block “pre-boiling” of a gas stove, and a block “pre-boiling” of an IH, are disposed in a region below a cooking process “pre-boiling root vegetables”. As described above, the selected block region D5 allows multiple blocks to be disposed for one cooking process.

The display controller 511 controls the communication unit 55 to acquire multiple blocks stored in the block database 41 via the communication network 90 to display the recipe creation screen W1. The display controller 511 classifies the acquired multiple blocks for each apparatus associated with the corresponding one of the blocks. The display controller 511 displays one or more list boxes for selecting a block associated with one or more of the apparatuses 20 in the block list region D2. FIG. 3 illustrates an example of the block list region D2 including list boxes displayed for selecting a block associated with one or more of the rice cooker, the microwave oven, the gas stove, the IH, the cutting board, and an automatic cooker.

The display controller 511 also acquires operations of one or more apparatuses 20 without duplication from operations of the multiple apparatuses 20 included in the acquired multiple blocks. The display controller 511 creates multiple combo boxes having the acquired one or more operations of the apparatuses 20 as selection items. Then, the display controller 511 displays the multiple created combo boxes in the cooking process setting region D3. FIG. 3 illustrates an example of the cooking process setting region D3, in which four combo boxes created by the display controller 511 are displayed.

The receiver 512 receives various operations on the recipe creation screen W1 with the creator.

Specifically, the receiver 512 receives an operation of creating multiple cooking processes. For details, the receiver 512 receives an operation of selecting or editing one cooking process with the creator using combo boxes included in the cooking process setting region D3 as an operation of creating one cooking process constituting a recipe. FIG. 3 illustrates an example of operations received by the receiver 512, in which an operation is performed to select “thawing meat”, “cutting ingredients”, “pre-boiling”, and “boiling” in the corresponding four combo boxes displayed by the display controller 511, and an operation is performed to edit “pre-boiling” to “pre-boiling root vegetables” in the combo box in which “boiling” is selected.

The receiver 512 receives an operation of selecting a block for constituting a recipe. Specifically, the receiver 512 receives an operation of selecting one block with the creator using the list box included in the block list region D2 as an operation of selecting one block constituting the recipe.

The receiver 512 receives an operation of associating multiple blocks constituting the recipe with corresponding cooking processes.

Specifically, it is assumed that the creator drags one block selected in the list box included in the block list region D2 onto a column in which one cooking process is displayed and drops the one block. In this case, the receiver 512 receives an operation of associating the one block with the one cooking process. When receiving the operation, the receiver 512 displays an image indicating the block associated with the cooking process by the operation on a column in which the cooking process is displayed.

When the apparatus 20 associated with the block is not displayed in the apparatus display region D4 at the beginning of a row in which the image indicating the block has been displayed, the receiver 512 displays the apparatus 20 associated with the block in the apparatus display region D4 at the beginning of the row.

For example, FIG. 3 illustrates an example in which the receiver 512 receives an operation of associating the block “thawing meat” of the microwave oven with the cooking process “thawing meat”. In this case, the receiver 512 displays an image indicating the block “thawing meat” of the microwave oven on a column in which the cooking process “thawing meat” is displayed, and displays the apparatus 20 “microwave oven” associated with the block in the apparatus display region D4 at the beginning of a row in which the image is displayed.

The receiver 512 further displays a setting screen of parameters in the parameter setting region D1, the parameters being settable in the blocks disposed in the selected block region D5. The receiver 512 receives an operation of selecting another block already disposed in the selected block region D5. Even in this case, the receiver 512 displays a setting screen of a parameter in the parameter setting region D1, the parameter being settable in the other block selected by the operation.

The receiver 512 receives an operation of setting parameters of respective blocks on the parameter setting screen of the respective blocks displayed in the parameter setting region D1. The parameters of the respective blocks include a cooking time for continuing an operation of the apparatus 20 or the instrument 21 included in each block, the instrument 21 used in the operation of the apparatus 20 included in each block, and the like.

Hereinafter, the cooking time for continuing the operation of the apparatus 20 or the instrument 21 included in each block is simply referred to as a cooking time of each block. Additionally, the instrument 21 used in the operation of the apparatus 20 or the instrument 21 included in each block is referred to as the instrument 21 associated with each block. When receiving the operation of setting parameters of respective blocks, the receiver 512 acquires the parameters of the respective blocks set by the operation.

The developer of the apparatus 20 may preset initial values of the parameters of the respective blocks. In this case, the receiver 512 displays the preset initial values of the parameters of the respective blocks in parameter setting fields of the corresponding blocks on the parameter setting screen.

The registration unit 513 registers recipe information in the recipe database 42, the recipe information indicating a recipe R1 created on the recipe creation screen W1.

Specifically, it is assumed that the creator performs an operation of pressing a completion button (not illustrated) provided on the recipe creation screen W1. In this case, the registration unit 513 creates information as the recipe information indicating the recipe R1 created on the recipe creation screen W1, the information including the multiple cooking processes displayed in the cooking process setting region D3 that are associated with corresponding one or more blocks.

The registration unit 513 causes the communication unit 55 to transmit the created recipe information to the application providing server 10 together with information requesting registration of the recipe R1. When acquiring the information requesting registration of the recipe R1 from the development terminal 50 via the communication network 90, the application providing server 10 accordingly stores the recipe information acquired from the development terminal 50 together with the information in the recipe database 42.

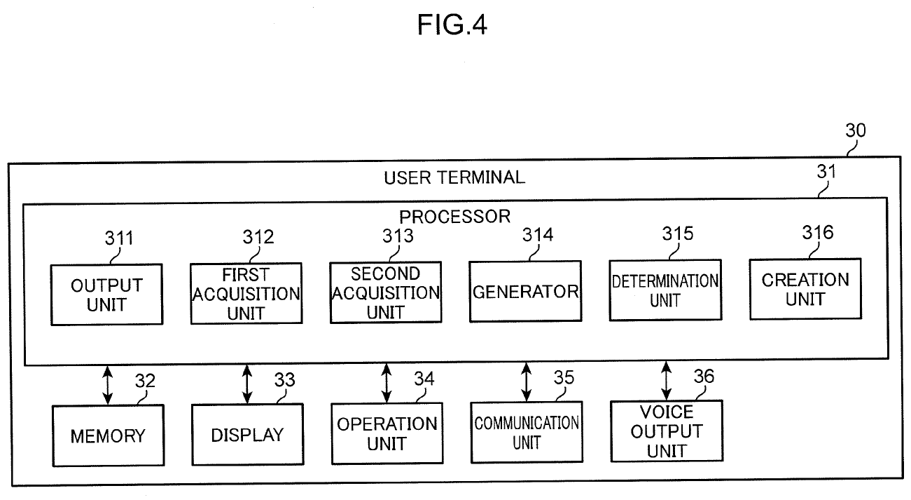

Next, details of the user terminal 30 will be described. FIG. 4 is a block diagram illustrating an example of a functional configuration of the user terminal 30. As illustrated in FIG. 4, the user terminal 30 includes a memory 32, a display 33, an operation unit 34, and a communication unit 35, which are similar to the memory 52, the display 53, the operation unit 54, and the communication unit 55 (FIG. 2) provided in the development terminal 50, respectively, and a processor 31, and a voice output unit 36.

The processor 31 includes a central processing unit (CPU), for example. The processor 31 includes an output unit 311, a first acquisition unit 312, a second acquisition unit 313, a generator 314, a determination unit 315, and a creation unit 316. The output unit 311 to the creation unit 316 are implemented when the processor 31 executes a recipe reference program, for example.

The voice output unit 36 includes a speaker, an earphone jack, or the like, and outputs various voices or voice signals instructed from the processor 31.

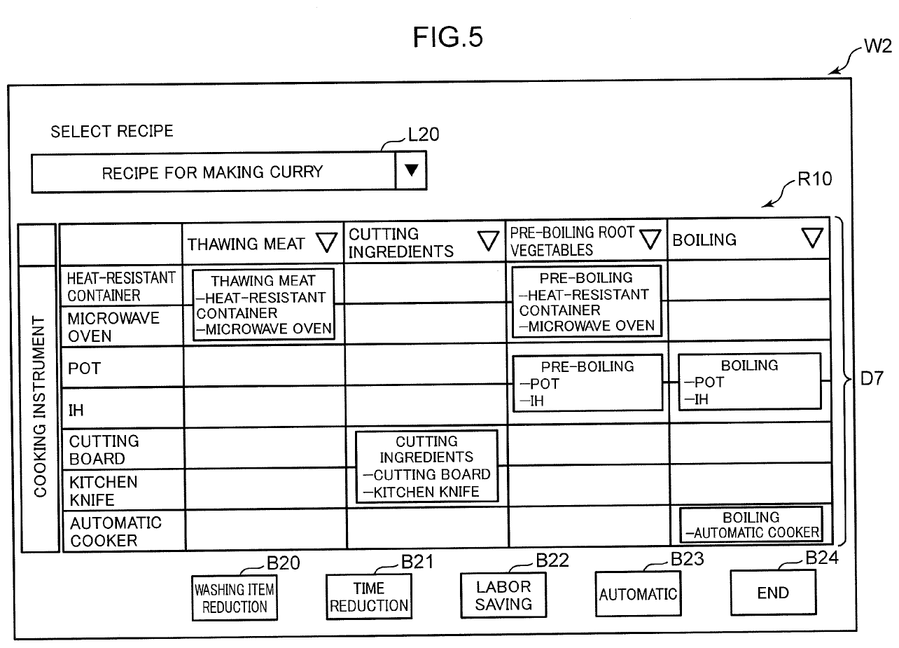

Hereinafter, details of the output unit 311 to the creation unit 316 will be described. FIG. 5 is a diagram illustrating an example of a recipe reference screen W2. When the user performs a predetermined operation using the operation unit 34, the output unit 311 causes the display 33 to display the recipe reference screen W2 as illustrated in FIG. 5.

Specifically, the output unit 311 outputs information to the display 33, the information indicating the recipe reference screen W2 to be displayed on the display 33. The information indicating the recipe reference screen W2 to be displayed on the display 33 includes screen data indicating the recipe reference screen W2 in a data format displayable on the display 33 such as a hypertext markup language (HTML) and information indicating an instruction to display the recipe reference screen W2 indicated by the screen data, for example.

As a result, the display 33 displays the recipe reference screen W2 according to the information received from the output unit 311. The recipe reference screen W2 includes a list box L20, a recipe display region D7, four recommendation buttons B20 to B23, and an end button B24.

The list box L20 is configured to select a recipe of a reference target from one or more recipes indicated by one or more pieces of recipe information stored in the recipe database 42.

The recipe display region D7 displays a user recipe (second recipe). The user recipe is generated by deleting blocks from a recipe selected using the list box L20, the blocks including a block including one or more apparatuses 20 and instruments 21 that are included in multiple blocks included in the recipe and are not included in the user apparatus information, and a block including one or more apparatuses 20 and instruments 21 each of which has an operation state indicating being in operation.

That is, the user recipe is generated by deleting blocks from the multiple blocks included in the recipe selected using the list box L20, the blocks including a block including an apparatus 20 or an instrument 21 different from the one or more apparatuses 20 and instruments 21 possessed by the user, and a block including the apparatus 20 and the instrument 21 in operation.

The recipe display region D7 displays multiple cooking processes included in the user recipe, and one or more blocks associated with the corresponding cooking processes in the user recipe, in an associated manner. The recipe display region D7 includes rows in which one or more of the blocks are displayed, and the apparatus 20 and the instrument 21 associated with the one or more of the blocks are displayed at the beginning of the corresponding rows.

For example, FIG. 5 illustrates an example in which the recipe R1 (FIG. 3) for making curry is selected using the list box L20, and a user recipe R10 generated from the selected recipe R1 is displayed in the recipe display region D7. FIG. 5 illustrates an example of the recipe display region D7 in which the block “thawing meat” of the microwave oven associated with the cooking process “thawing meat” of the user recipe R10 is displayed in rows and the microwave oven and the heat-resistant container that are respectively the apparatus 20 and the instrument 21 associated with the block are displayed at the beginnings of the corresponding rows.

The four recommendation buttons B20 to B23 are each used to display one or more recommended recipes (third recipes) created by customizing the user recipe R10 displayed in the recipe display region D7 according to a rule associated with the corresponding one of the recommendation buttons B20 to B23. The end button B24 is used to close the recipe reference screen W2.

To cause the display 33 to display the recipe reference screen W2, the output unit 311 controls the communication unit 35 to acquire a list of names of recipes indicated by the recipe information stored in the recipe database 42 via the communication network 90. The output unit 311 causes the display 33 to output the recipe reference screen W2 including the list box L20 having the acquired list of names of recipes as selection items.

The output unit 311 controls the display 33 to hide the recipe reference screen W2 when the user performs an operation of pressing the end button B24.

The first acquisition unit 312 receives various operations on the recipe reference screen W2 with the user.

Specifically, the first acquisition unit 312 receives an operation of selecting a recipe of a reference target. For details, the first acquisition unit 312 receives an operation of selecting one recipe with the user using the list box L20 as an operation of selecting a recipe of a reference target. FIG. 5 illustrates the example in which the first acquisition unit 312 receives an operation of selecting the recipe R1 (FIG. 3) for making curry as a recipe of a reference target.

When receiving an operation of selecting a recipe of a reference target, the first acquisition unit 312 requests the application providing server 10 to provide recipe information indicating the recipe of a reference target selected by the operation. The application providing server 10 accordingly acquires the recipe information requested from the user terminal 30 from the recipe database 42 and returns the recipe information to the user terminal 30. As a result, the first acquisition unit 312 acquires the recipe information indicating the recipe (first recipe) of a reference target selected by the user.

The second acquisition unit 313 acquires apparatus information (hereinafter, user apparatus information) indicating the one or more apparatuses 20 and instruments 21 possessed by the user, and information indicating operation states of the one or more apparatuses 20 and instruments 21 indicated by the user apparatus information.

Specifically, the second acquisition unit 313 requests the application providing server 10 to transmit the user apparatus information and log information on the one or more apparatus 20 indicated by the user apparatus information for a latest predetermined period (e.g., 10 minutes) stored in the log database 43, via the communication network 90.

The application providing server 10 accordingly acquires the user apparatus information requested from the user terminal 30 and the log information on the one or more apparatus 20 indicated by the user apparatus information for the latest predetermined period from the recipe database 42 and returns them to the user terminal 30, via the communication network 90.

As a result, the second acquisition unit 313 acquires apparatus information indicating the one or more apparatuses 20 and instruments 21 possessed by the user, and acquires the log information on the one or more apparatuses 20 indicated by the apparatus information for the latest predetermined period as information indicating operation states of the one or more apparatuses 20 indicated by the apparatus information.

The second acquisition unit 313 also acquires information indicating operation states of one or more instruments 21 possessed by the user, the information being input by operation of the operation unit 34 with the user. The information indicating the operation states of the one or more instruments 21 includes a current date and time, identification information on the one or more instruments 21, information indicating whether the one or more instruments 21 are in operation, a use time of the one or more instruments 21, and the like. An instrument 21 in operation indicates that the instrument 21 is in use by the user.

The generator 314 deletes a block from the recipe indicated by the recipe information acquired by the first acquisition unit 312, the block including one or more apparatuses 20 and instruments 21 that are included in multiple blocks included in the recipe and are not included in the user apparatus information acquired by the second acquisition unit 313. That is, the generator 314 deletes a block from the recipe indicated by the recipe information acquired by the first acquisition unit 312, the block including an apparatus 20 or an instrument 21 different from the one or more apparatuses 20 and instruments 21 indicated by the user apparatus information acquired by the second acquisition unit 313.

The generator 314 further refers to the information indicating the operation states of the one or more apparatuses 20 and instruments 21 indicated by the user apparatus information acquired by the second acquisition unit 313, and deletes, from the recipe in which the block described above is deleted, a block indicating the one or more apparatuses 20 and instruments 21 having operation states indicating being in operation. As a result, the generator 314 generates a recipe after deleting these two types of blocks as a user recipe.

For example, when a half or more of log information items on a certain apparatus 20 for the latest predetermined period acquired by the second acquisition unit 313 indicate that the certain apparatus 20 is in operation, the generator 314 determines the certain apparatus 20 as an apparatus having an operation state indicating being in operation. Besides this, the generator 314 may determine the apparatus 20 having the operation state indicating being in operation by using log information acquired by the second acquisition unit 313 by another method.

Similarly to the output unit 311, the generator 314 causes the display 33 to display the recipe reference screen W2 on which the generated user recipe is displayed in the recipe display region D7. The generator 314 causes the display 33 to display the recipe reference screen W2 including the recipe display region D7 in which blocks are displayed in corresponding rows with beginnings at each of which the apparatus 20 or the instrument 21 associated with one or more of the blocks is displayed.

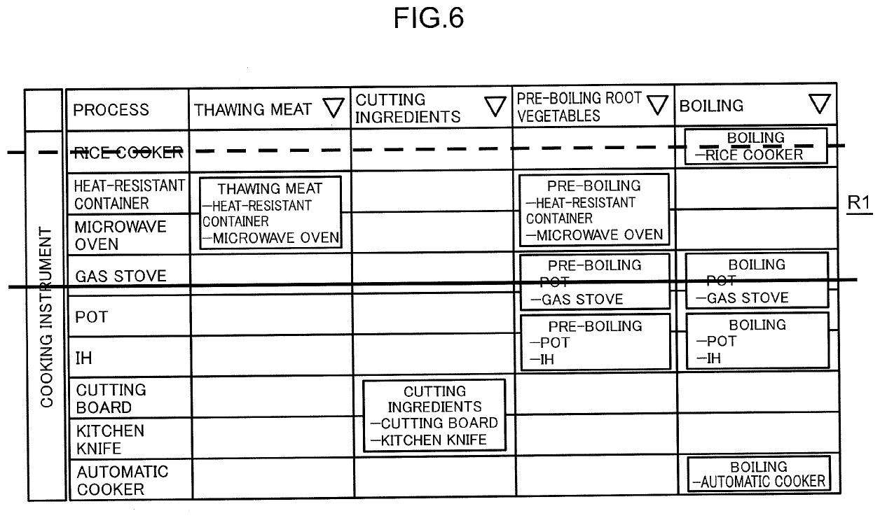

FIG. 6 is a diagram illustrating an example of generating a user recipe. For example, it is assumed that the first acquisition unit 312 acquires the recipe R1 (FIG. 3) for making curry. It is also assumed that the second acquisition unit 313 acquires the user apparatus information that includes a heat-resistant container, a microwave oven, a rice cooker, an IH, a pot, a cutting board, a kitchen knife, and an automatic cooker. It is also assumed that five apparatuses 20 (the microwave oven, the rice cooker, the IH, the cutting board, and the automatic cooker) included in the apparatus information acquired by the second acquisition unit 313 have log information items including a log information item of the rice cooker, indicating that the rice cooker is in operation. It is also assumed that the second acquisition unit 313 has not acquired information indicating an operation state of the kitchen knife.

FIG. 6 illustrates an example in which the generator 314 generates the user recipe from the recipe R1 for curry in this case. Specifically, FIG. 6 displays four cooking processes and nine blocks included in the recipe R1 for curry in association with each other, and the blocks are displayed in corresponding rows with beginnings at each of which the apparatus 20 or the instrument 21 associated with one or more of the blocks is displayed.

The gas stove is not included in the user apparatus information in the present example, so that the generator 314 deletes the block “pre-boiling” of the gas stove and the block “boiling” of the gas stove, indicating the gas stove that is not included in the user apparatus information, from the recipe R1 for curry as indicated by a solid line in FIG. 6. As indicated by a broken line in FIG. 6, the generator 314 refers to the information acquired by the second acquisition unit 313 to delete the block “boiling” of the rice cooker having an operation state indicating being in operation.

As a result, the generator 314 generates the user recipe R10 (FIG. 5) in which the block “thawing meat” of the microwave oven and the block “cutting ingredients” of the cutting board are associated with the cooking process “thawing meat” and the cooking process “cutting ingredients”, respectively, and two blocks are associated with each of the cooking process “pre-boiling root vegetables” and the cooking process “boiling”.

As illustrated in FIG. 5, the generator 314 causes the display 33 to display the recipe reference screen W2 on which the generated user recipe R10 is displayed in the recipe display region D7. Specifically, the generator 314 causes the display 33 to display the recipe reference screen W2 with the recipe display region D7 in which the four cooking processes “thawing meat”, “cutting ingredients”, “pre-boiling root vegetables”, and “boiling” included in the user recipe R10 are associated with one or more blocks that are associated with the corresponding cooking processes in the user recipe R10.

The generator 314 causes the display 33 to display the recipe reference screen W2 including the recipe display region D7 in which blocks are displayed in corresponding rows with beginnings at each of which the apparatus 20 or the instrument 21 associated with one or more of the blocks is displayed. The generator 314 also causes the display 33 to display the recipe reference screen W2 in which an image indicating each of the blocks included in the user recipe R10 has a width that is changed in accordance with a cooking time of the corresponding one of the blocks.

For example, the generator 314 adjusts a width of an image indicating a block with a cooking time of a first time so that the width becomes narrower than a width of an image indicating a block with a cooking time of a second time longer than the first time. FIG. 5 illustrates the example in which an image indicating the block “pre-boiling” of the microwave oven has a shorter width than an image indicating the block “pre-boiling” of the IH because a cooking time of the block “pre-boiling” of the microwave oven associated with the cooking process “pre-boiling root vegetables” is shorter than a cooking time of the block “pre-boiling” of the IH associated with the cooking process “pre-boiling root vegetables”.

When detecting a cooking process (referred to below as a first cooking process) associated with multiple blocks from the user recipe R10, the determination unit 315 determines a first block from among the multiple blocks associated with the first cooking process according to one or more rules.

Specifically, when the user presses any one of the four recommendation buttons B20 to B23 on the recipe reference screen W2, the determination unit 315 detects the first cooking process associated with the multiple blocks in the user recipe R10 displayed in the recipe display region D7. The example of FIG. 5 shows the user recipe R10 in which two cooking processes of “pre-boiling root vegetables” and “boiling” are each associated with two blocks, and thus are each detected as the first cooking process.

When detecting the first cooking process, the determination unit 315 determines the first block from among the multiple blocks associated with the first cooking process according to a rule associated with the pressed recommendation button.

(Method for Determining First Block According to Washing Item Reduction Rule)

When the recommendation button B20 is pressed, the determination unit 315 receives input of a washing item reduction rule (first rule) associated with the recommendation button B20. In this case, the determination unit 315 determines the first block from among the multiple blocks associated with the first cooking process according to the washing item reduction rule.

Specifically, when detecting a cooking process (referred to below as a second cooking process) associated with only one block from the user recipe R10, the determination unit 315 determines a block as the first block from among the multiple blocks associated with the first cooking process, the block being associated with the apparatus 20 with which the one block is associated.

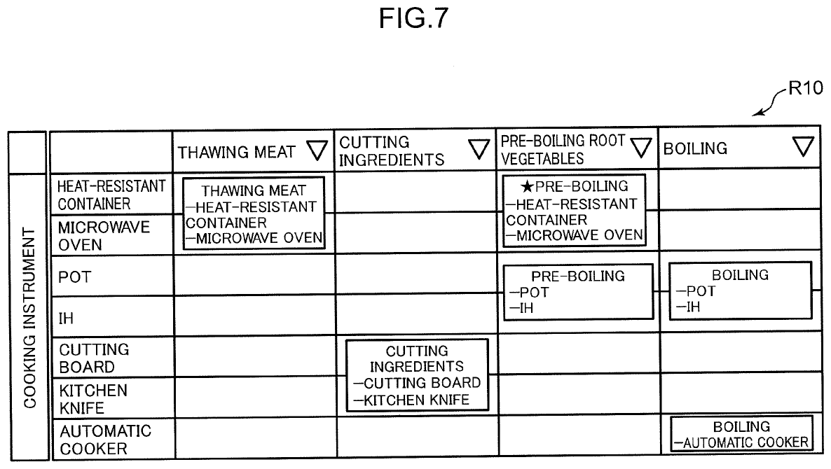

FIG. 7 is a diagram illustrating an example of a method for determining the first block according to the washing item reduction rule. FIG. 7 illustrates the user recipe R10 displayed on the recipe reference screen W2 illustrated in FIG. 5. In this case, when the recommendation button B20 is pressed, the determination unit 315 determines the first block from among the multiple blocks associated with the cooking process “pre-boiling root vegetables” of the first cooking process, according to the washing item reduction rule.

In the present example, the determination unit 315 detects the cooking process “thawing meat” with which only the block “thawing meat” of the microwave oven is associated, as the second cooking process. The determination unit 315 also detects the cooking process “cutting ingredients” with which only the block “cutting ingredients” of the cutting board is associated, as the second cooking process.

When detecting the second cooking process, the determination unit 315 determines the block “pre-boiling” of the microwave oven as the first block, from between the block “pre-boiling” of the microwave oven and the block “pre-boiling” of the IH that are associated with the cooking process “pre-boiling root vegetables” of the first cooking process, the block “pre-boiling” of the microwave oven being associated with the apparatus 20 with which the block “thawing meat” of the microwave oven associated with the cooking process “thawing meat” of the second cooking process is associated. FIG. 7 shows the first block determined according to the washing item reduction rule with a star sign.

The determination unit 315 also detects that the block “boiling” of the IR and the block “boiling” of the automatic cooker, which are associated with the cooking process “boiling” of the first cooking process, are not associated with the apparatus 20 with which the block “thawing meat” of the microwave oven associated with the cooking process “thawing meat” of the second cooking process and the block “cutting ingredients” of the cutting board associated with the cooking process “cutting ingredients” of the second cooking process are associated. In this case, the determination unit 315 selects one block by a predetermined method from among multiple blocks associated with the cooking process “boiling” of the first cooking process, and determines the selected one block as the first block.

Examples of the predetermined method include a method for randomly selecting one block. The examples of the predetermined method also include a method for storing a block in association with a priority when the block is stored in the block database 41, and selecting a block associated with the highest priority. The examples of the predetermined method further include a method for selecting a block included in the largest number of recipes among recipes indicated by the recipe information stored in the recipe database 42.

It is also conceivable that multiple first blocks are determined when multiple second cooking processes are detected as in the present example. In this case, the determination unit 315 may determine one block selected from among the multiple first blocks by the predetermined method as the first block.

(Method for Determining First Block According to Time Reduction Rule)

When the recommendation button B21 is pressed, the determination unit 315 receives input of a time reduction rule (second rule) associated with the recommendation button B21. In this case, the determination unit 315 determines the first block from among the multiple blocks associated with the first cooking process according to the time reduction rule.

Specifically, the determination unit 315 determines a block as the first block from among the multiple blocks associated with the first cooking process, the block including the shortest cooking time.

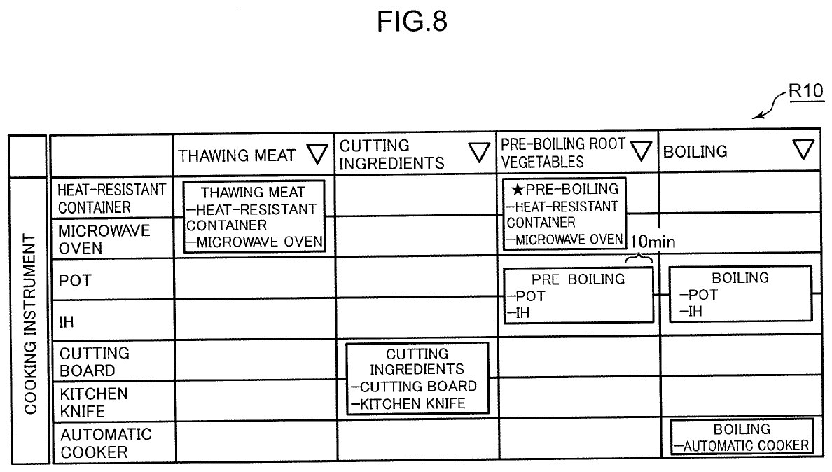

FIG. 8 is a diagram illustrating an example of a method for determining the first block according to the time reduction rule. FIG. 8 illustrates the user recipe R10 displayed on the recipe reference screen W2 illustrated in FIG. 5, similarly to FIG. 7. In this case, when the recommendation button B21 is pressed, the determination unit 315 determines the first block from among the multiple blocks associated with the cooking process “pre-boiling root vegetables” of the first cooking process, according to the time reduction rule.

It is assumed in the present example that the block “pre-boiling” of the microwave oven, the block being associated with the cooking process “pre-boiling root vegetables” of the first cooking process, has a cooking time that is 10 minutes shorter than that of the block “pre-boiling” of the IH. In this case, the determination unit 315 determines the block “pre-boiling” of the microwave oven as the first block from among the multiple blocks associated with the cooking process “pre-boiling root vegetables” of the first cooking process, the block “pre-boiling” of the microwave oven including the shortest cooking time. FIG. 8 shows the first block determined according to the time reduction rule with a star sign.

It is assumed that the block “boiling” of the IH associated with the cooking process “boiling” of the first cooking process has a cooking time equal to a cooking time of the block “boiling” of the automatic cooker. In this case, a block including the shortest cooking time cannot be specified from the multiple blocks associated with the cooking process “boiling” of the first cooking process. In such a case, the determination unit 315 selects one block by the predetermined method described above, and determines the selected one block as the first block.

(Method for Determining First Block According to Labor Saving Rule)

When the recommendation button B22 is pressed, the determination unit 315 receives input of a labor saving rule (third rule) associated with the recommendation button B22. In this case, the determination unit 315 determines the first block from among the multiple blocks associated with the first cooking process according to the labor saving rule.

Specifically, the determination unit 315 determines a block as the first block from among the multiple blocks associated with the first cooking process, the block indicating the lowest intervention degree.

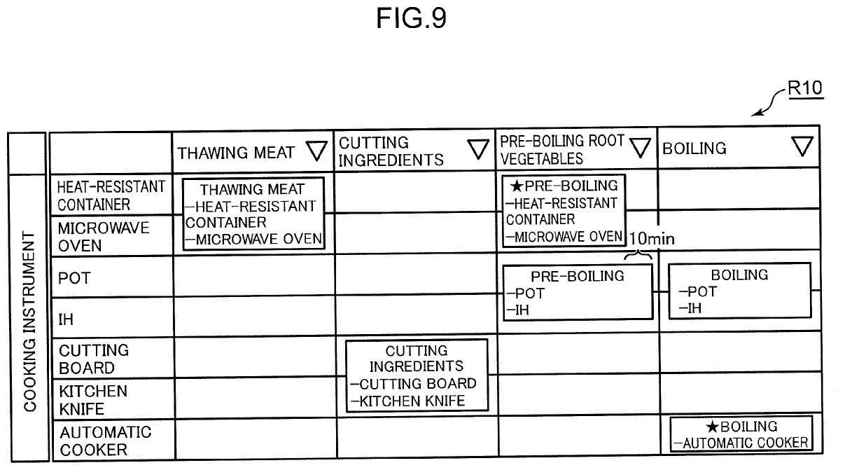

FIG. 9 is a diagram illustrating an example of a method for determining the first block according to the labor saving rule. FIG. 9 illustrates the user recipe R10 displayed on the recipe reference screen W2 illustrated in FIG. 5, similarly to FIGS. 7 and 8. In this case, when the recommendation button B22 is pressed, the determination unit 315 determines the first block from among the multiple blocks associated with the cooking process “pre-boiling root vegetables” of the first cooking process, according to the labor saving rule.

It is assumed in the present example that each of blocks of the kitchen knife and the cutting board has an intervention degree being defined as 3, each of blocks of the IH and the gas stove has an intervention degree being defined as 2, and each of blocks of the automatic cooker and the microwave oven has an intervention degree being defined as 1. In this case, the determination unit 315 determines the block “pre-boiling” of the microwave oven as the first block from among the multiple blocks associated with cooking process “pre-boiling root vegetables” of the first cooking process, the block “pre-boiling” of the microwave oven having the lowest intervention degree. The determination unit 315 also determines the block “boiling” of the automatic cooker as the first block from among the multiple blocks associated with the cooking process “boiling” of the first cooking process, the block “boiling” of the automatic cooker having the lowest intervention degree. FIG. 9 shows the first block determined according to the labor saving rule with a star sign.

When the multiple blocks associated with the first cooking process have the same intervention degree, the first block cannot be specified. In such a case, the determination unit 315 selects one block by the predetermined method described above, and determines the selected one block as the first block.

(Method for Determining First Block According to Automatic Rule)

When the recommendation button B23 is pressed, the determination unit 315 receives input of an automatic rule associated with the recommendation button B23. In this case, the determination unit 315 determines the first block from among the multiple blocks associated with the first cooking process according to the automatic rule. The determination unit 315 then sets a priority as a parameter of each block, the priority indicating a degree of a preferable display of the block with respect to other blocks.

Specifically, after setting a priority of 0 to the multiple blocks associated with the first cooking process, the determination unit 315 adds a predetermined first priority to the first block determined by the washing item reduction rule described above, adds a predetermined second priority to the first block determined by the time reduction rule described above, and adds a predetermined third priority to the first block determined by the labor saving rule described above. Then, the determination unit 315 determines a block as the first block from among the multiple blocks associated with the first cooking process, the block having the highest priority.

When the multiple blocks associated with the first cooking process include multiple blocks having the highest priority, the determination unit 315 selects one block from among the multiple blocks having the highest priority by the predetermined method, and determines the selected one block as the first block.

The creation unit 316 associates the first block determined by the determination unit 315 according to the one or more rules with the first cooking process in the user recipe R10 to create one or more recommended recipes (third recipes) according to the one or more rules. Similarly to the output unit 311, the creation unit 316 causes the display 33 to display the recipe reference screen W2 including the created one or more recommended recipes.

Specifically, it is assumed that the determination unit 315 determines the first block according to any one of the washing item reduction rule, the time reduction rule, and the labor saving rule. In this case, the creation unit 316 creates a recipe as one recommended recipe, the recipe including the determined first block associated with the first cooking process in the user recipe R10 and one block associated with the second cooking process in the user recipe R10 as in the user recipe R10.

For example, it is assumed that the determination unit 315 determines the first block, which is to be associated with the first cooking process in the user recipe R10 illustrated in FIG. 5, by the labor saving rule. As illustrated in FIG. 9, it is accordingly assumed that the block “pre-boiling” of the microwave oven is determined as the first block to be associated with the cooking process “pre-boiling root vegetables” of the first cooking process, and the block “boiling” of the automatic cooker is determined as the first block to be associated with the cooking process “boiling” of the first cooking process.

In this case, the creation unit 316 creates a recipe as one recommended recipe according to the labor saving rule, the recipe including: the block “pre-boiling” of the microwave oven and the block “boiling” of the automatic cooker that are each determined as the first block and that are respectively associated with the cooking process “pre-boiling root vegetables” and the cooking process “boiling”, which are each the first cooking process in the user recipe R10; and the block “thawing meat” of the microwave oven and the block “cutting ingredients” of the cutting board that are respectively associated with the cooking process “thawing meat” and the cooking process “cutting ingredients”, which are each the second cooking process, as in the user recipe R10.

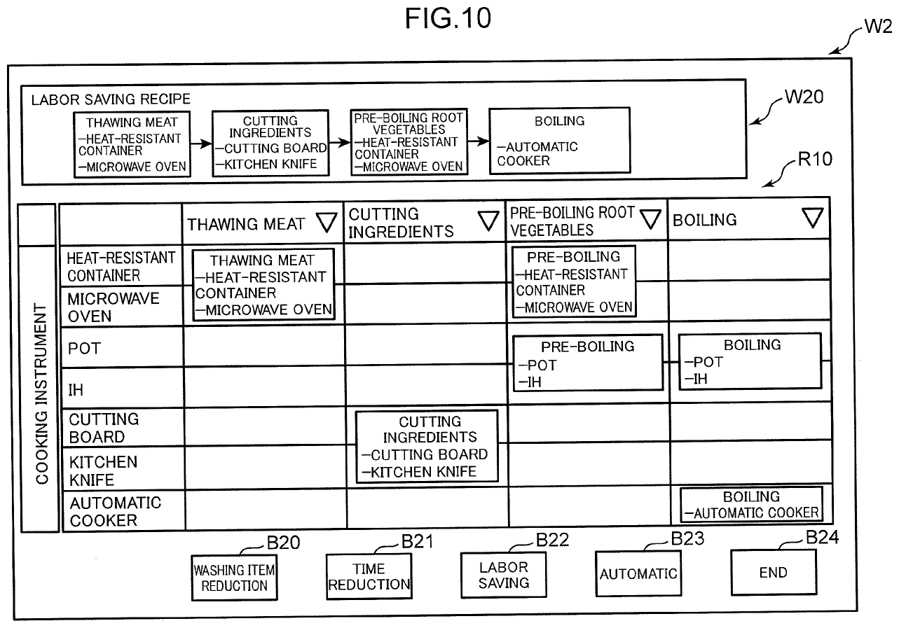

FIG. 10 is a diagram illustrating a display example of a recommended recipe W20 created when the first block is determined by the labor saving rule. The creation unit 316 outputs information that indicates the recipe reference screen W2 including the created recommended recipe W20 to the display 33, and that is to be displayed on the display 33. As a result, the display 33 displays the recipe reference screen W2 including the created recommended recipe W20 as illustrated in FIG. 10.

Alternatively, it is assumed that the determination unit 315 determines the first block according to the automatic rule. In this case, the creation unit 316 creates a recipe as the first recommended recipe according to the automatic rule, the recipe including: the determined first block associated with the first cooking process in the user recipe R10; and one block associated with the second cooking process in the user recipe R10 as in the user recipe R10.

The creation unit 316 also creates a recipe as the second recommended recipe according to the automatic rule, the recipe including: a block having the second highest priority associated with the first cooking process in the user recipe R10; and one block associated with the second cooking process in the user recipe R10 as in the user recipe R10.

As described above, the creation unit 316 creates multiple recipes as multiple recommended recipes according to the automatic rule, the multiple recipes including: blocks associated with the first cooking process in the user recipe R10 in descending order of priority; and one block associated with the second cooking process in the user recipe R10 as in the user recipe R10.

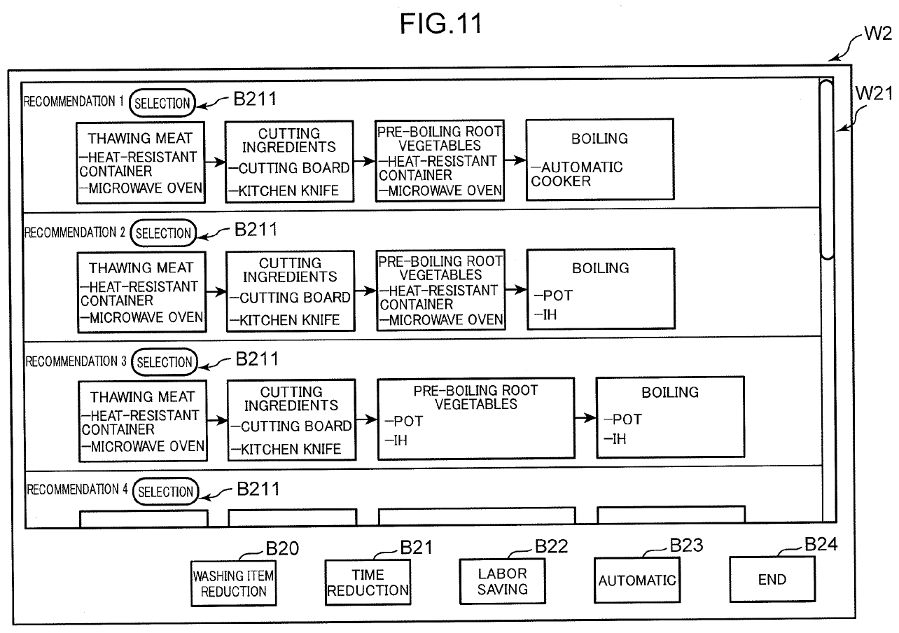

FIG. 11 is a diagram illustrating a display example of multiple recommended recipes W21 created when the first block is determined by the automatic rule. FIG. 11 illustrates an example of the multiple recommended recipes W21, including the first recommended recipe “Recommendation 1”, the second recommended recipe “Recommendation 2”, the third recommended recipe “Recommendation 3”, and the fourth recommended recipe “Recommendation 4”.

When the first block is determined by the automatic rule, the creation unit 316 causes the display 33 to display the recipe reference screen W2 including selection buttons B211 associated with the respective multiple recommended recipes W21 as illustrated in FIG. 11. When one of the selection buttons B211 is pressed by the user, the creation unit 316 causes the display 33 to display the recipe reference screen W2 including a recommended recipe associated with the pressed selection button B211 as one recommended recipe W20 similarly to FIG. 10.

For example, it is assumed that the selection button B211 displayed on the right of the first recommended recipe “Recommendation 1” in FIG. 11 is pressed. In this case, the creation unit 316 causes the display 33 to display the recipe reference screen W2 including the first recommended recipe “Recommendation 1” associated with the selection button B211 as one recommended recipe W20 as illustrated in FIG. 10.

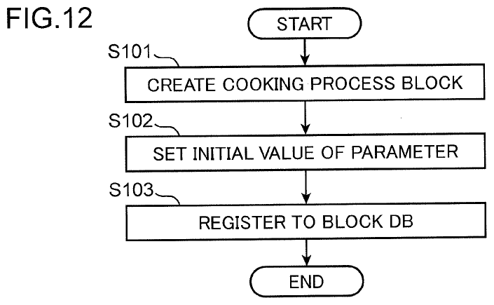

Next, a method for registering a block will be described. FIG. 12 is a flowchart illustrating an example of the method for registering a block.

The developer of the apparatus 20 performs steps S101 to S103 by operating an information processing device such as a personal computer (not illustrated) that can communicate with the application providing server 10 via the communication network 90. In step S101, the developer of the apparatus 20 creates a block indicating an operation associated with the cooking process. For example, the developer of the microwave oven creates the block “thawing meat” of the microwave oven that shows an operation associated with the cooking process “thawing meat”.

In step S102, the developer of the apparatus 20 sets an initial value of a parameter of the block created in step S101. For example, the developer of the microwave oven sets a heat-resistant container as an initial value of a parameter indicating the instrument 21 used in an operation of thawing meat indicated by the block “thawing meat” of the microwave oven.

In step S103, the developer of the apparatus 20 registers a block in the block database 41, the block being created in step S101 and having the initial value of the parameter set in step S102. Specifically in step S103, the developer of the apparatus 20 requests the application providing server 10 to register the block created in step S101 and having the initial value of the parameter set in step S102 in the block database 41. The application providing server 10 stores the block created by the above information processing device in the block database 41 via the communication network 90 in response to the request from the above information processing device.

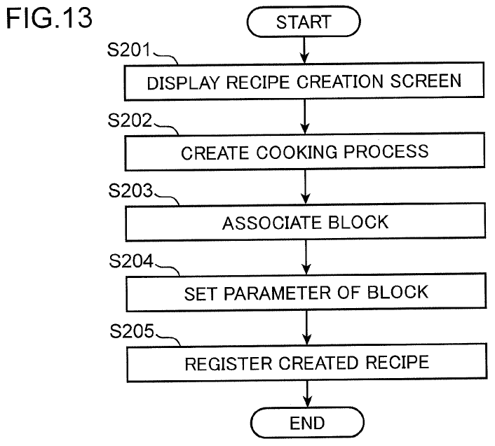

Next, a flow of processing of creating a recipe in the development terminal 50 will be described. FIG. 13 is a flowchart illustrating an example of the processing of creating a recipe.

When the creator performs a predetermined operation using the operation unit 54, the display controller 511 displays the recipe creation screen W1 (FIG. 3) on the display 53 in step S201. This operation starts the processing of creating a recipe illustrated in FIG. 13.

In step S202, the receiver 512 receives an operation of creating multiple cooking processes constituting the recipe.

In step S203, the receiver 512 receives an operation of selecting a block for constituting the recipe, and receives an operation of associating the block selected by the operation with any one of the cooking processes created in step S202. Repeating this operation allows one or more blocks to be associated with the corresponding multiple cooking processes.

In step S204, the receiver 512 displays a setting screen of a parameter of one of the blocks associated with the corresponding cooking processes in step S203 in the parameter setting region D1 (FIG. 3), and receives an operation of setting the parameter of the one of the blocks in the setting screen. Repeating this operation allows a parameter to be set to each of the multiple blocks.

In step S205, the registration unit 513 registers recipe information in the recipe database 42, the recipe information indicating a recipe R1 created on the recipe creation screen W1.

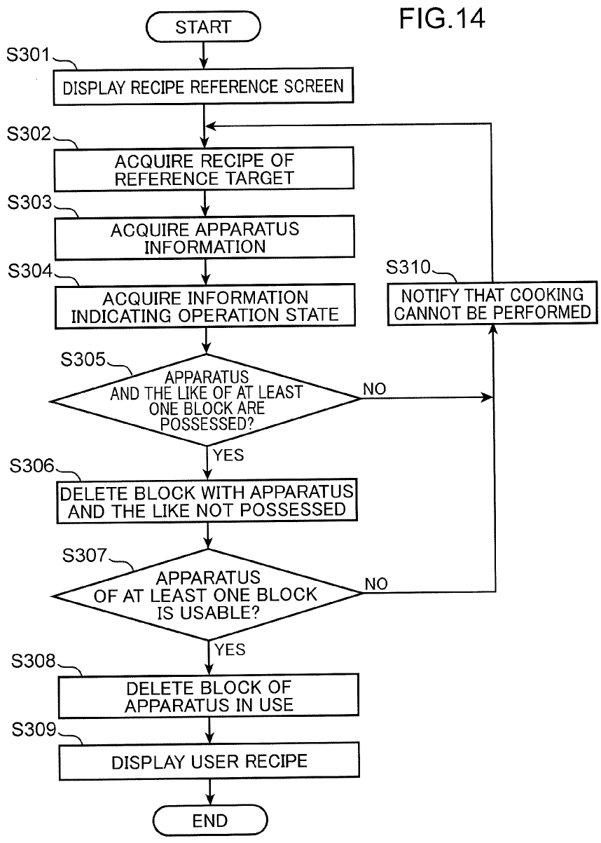

Next, a flow of processing of displaying a user recipe in the user terminal 30 will be described. FIG. 14 is a flowchart illustrating an example of the processing of displaying a user recipe.

When the creator performs a predetermined operation using the operation unit 34, the output unit 311 displays the recipe reference screen W2 on the display 33 in step S301. This operation starts the processing of displaying a user recipe illustrated in FIG. 14.

In step S302, the first acquisition unit 312 receives an operation of selecting a recipe of a reference target on the recipe reference screen W2, and acquires recipe information indicating the recipe of a reference target stored in the recipe database 42 via the application providing server 10.

In step S303, the second acquisition unit 313 acquires apparatus information via the application providing server 10, the apparatus information indicating one or more apparatuses 20 and instruments 21 possessed by the user and stored in the log database 43.

In step S304, the second acquisition unit 313 acquires information indicating operation states of the one or more apparatuses 20 and instruments 21 indicated by the apparatus information acquired in step S303.

In step S305, the generator 314 determines whether the user possesses the apparatus 20 and instrument 21 associated with at least one block of one or more blocks associated with corresponding cooking processes for each of the cooking processes of the recipe indicated by the recipe information acquired in step S302.

Specifically in step S305, the generator 314 determines whether each of the cooking processes of the recipe indicated by the recipe information acquired in step S302 is associated with one or more blocks associated with the one or more apparatuses 20 and instruments 21 indicated by the apparatus information acquired in step S303.

It is assumed in step S305 that the generator 314 determines that a block associated with the one or more apparatuses 20 and instruments 21 indicated by the apparatus information acquired in step S303 is not associated with one cooking process of the recipe indicated by the recipe information acquired in step S302. In this case (NO in step S305), the generator 314 causes the recipe reference screen W2, in step S310, to notify that cooking cannot be performed according to the recipe selected in step S302.

Specifically, the generator 314 causes the display 33, in step S310, to display the recipe reference screen W2 including a message indicating that cooking cannot be performed according to the recipe selected in step S302. Besides this, the generator 314 may cause the voice output unit 36 (FIG. 4), in step S310, to output a voice indicating that cooking cannot be performed according to the recipe selected in step S302. Step S310 allows the user to easily grasp that the cooking according to the recipe selected as the recipe of a reference target in step S302 cannot be performed. After that, the processing in and after step S302 is performed.

In contrast, it is assumed in step S305 that the generator 314 determines that one or more blocks associated with the corresponding one or more apparatuses 20 and instruments 21 indicated by the apparatus information acquired in step S303 are associated with corresponding all cooking processes of the recipe indicated by the recipe information acquired in step S302.

In this case (YES in step S305), the generator 314 deletes a block in step S306 from the recipe indicated by the recipe information acquired in step S302, the block being associated with one or more apparatuses 20 and instruments 21 that are included in multiple blocks included in the recipe and are not included in the apparatus information acquired in step S303. That is, the generator 314 deletes a block including an apparatus 20 or an instrument 21 different from the one or more apparatuses 20 and instruments 21 indicated by the apparatus information acquired in step S303 from the recipe indicated by the recipe information acquired in step S302.

In subsequent step S307, the generator 314 determines whether the apparatus 20 and the instrument 21 are usable, the apparatus 20 and the instrument 21 being associated with at least one block of one or more blocks associated with the corresponding cooking processes, for each of the cooking processes of the recipe after the block is deleted in step S306.

Specifically, in step S307, the generator 314 refers to the information acquired in step S304 to determine whether one or more blocks are associated with each of the cooking processes of the recipe after the block is deleted in step S306, the one or more blocks being associated with an apparatus 20 and an instrument 21 different from the apparatus 20 and the instrument 21 having an operation state indicating being in operation.

It is assumed in step S307 that the generator 314 determines that a block is not associated with one or more cooking processes of the recipe after the block is deleted in step S306, the block being associated with an apparatus 20 and an instrument 21 different from the apparatus 20 and the instrument 21 having an operation state indicating being in operation. In this case (NO in step S307), step S310 is performed, and then the processing in and after step S302 is performed.

In contrast, it is assumed in step S307 that the generator 314 determines that one or more blocks are associated with corresponding all cooking processes of the recipe after the block is deleted in step S306, the one or more blocks being associated with an apparatus 20 and an instrument 21 different from the apparatus 20 and the instrument 21 having an operation state indicating being in operation.

In this case (YES in step S307), the generator 314 deletes a block in step S308 from the recipe after the block is deleted in step S306, the block being associated with the apparatus 20 and the instrument 21 having the operation state indicating being in operation.

In step S309, the generator 314 causes the display 33 to display the recipe reference screen W2 on which the user recipe, which is the recipe after the block is deleted in step S308, is displayed in the recipe display region D7 (FIG. 5).

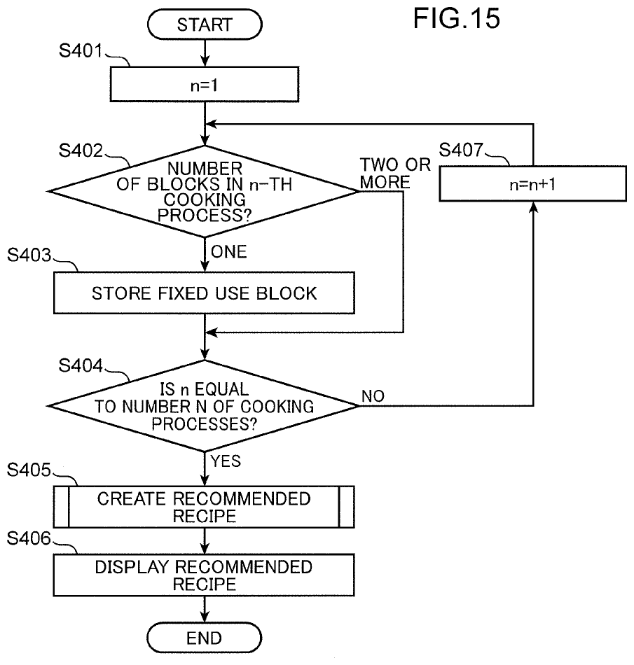

Next, a flow of processing of displaying a recommended recipe will be described. FIG. 15 is a flowchart illustrating an example of processing of displaying a recommended recipe.

When any one of the four recommendation buttons B20 to B23 on the recipe reference screen W2 (FIG. 5) is pressed, the processing of displaying a recommended recipe illustrated in FIG. is started, and then the first cooking process and the second cooking process are detected from the user recipe R10 in steps S401 to S404.

Specifically in step S401, the determination unit 315 sets a variable n to 1. In step S402, the determination unit 315 counts the number of blocks associated with the n-th cooking process in the user recipe R10.

When the number of blocks associated with the n-th cooking process is 2 or more (2 or more in step S402) in step S402, the determination unit 315 detects the n-th cooking process as the first cooking process, and the processing proceeds to step S404. When the number of blocks associated with the n-th cooking process is 1 (1 in step S402) in step S402, the determination unit 315 detects the n-th cooking process as the second cooking process. In this case, the determination unit 315 stores one block associated with the second cooking process in memory 32 as a fixed use block in step S403.

When the variable n does not coincide with the number N of cooking processes of the user recipe R10 (NO in step S404) in step S404, the determination unit 315 increments the variable n by 1 in step S407 to repeat the processing in and after step S402.

In subsequent step S405, the determination unit 315 and the creation unit 316 create one or more recommended recipes according to a rule associated with a pressed button among the four recommendation buttons B20 to B23. Details of step S405 will be described later.

In step S406, the creation unit 316 causes the display 33 to display the recipe reference screen W2 including the one or more recommended recipes created in step S405.

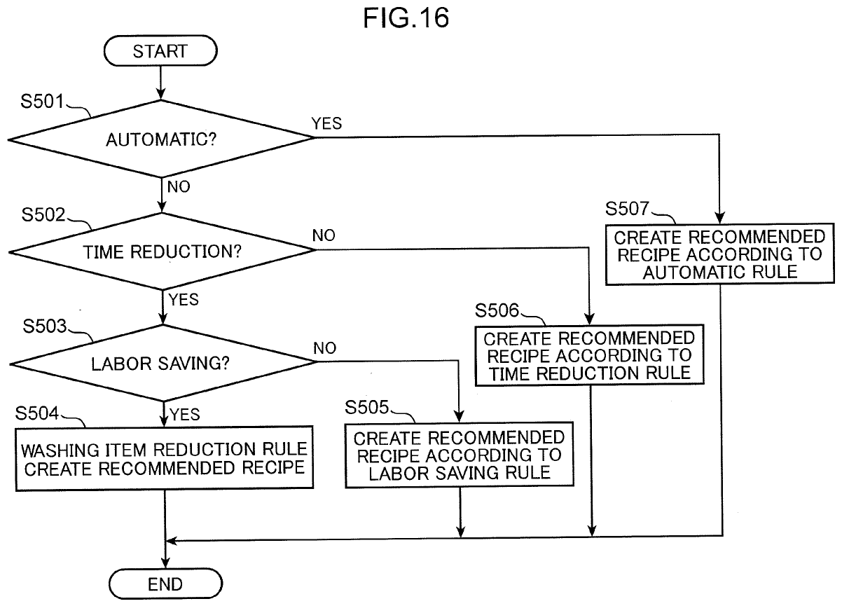

Next, the details of step S405 (FIG. 15) will be described. FIG. 16 is a flowchart illustrating an example of processing of creating a recommended recipe.

When step S405 (FIG. 15) is started, the processing of creating a recommended recipe illustrated in FIG. 16 is started, and then it is determined, in steps S501 to S503, which button of the four recommendation buttons B20 to B23 (FIG. 5) has been pressed. In subsequent steps S504 to S507, one or more recommended recipes are created according to a rule based on the determination results in steps S501 to S503.

Specifically, the determination unit 315 determines whether the recommendation button B23 has been pressed in step S501, determines whether the recommendation button B21 has been pressed in step S502, and determines whether the recommendation button B22 has been pressed in step S503.

The determination unit 315 determines that the recommendation button B20 has been pressed when determining that the recommendation button B23 has not been pressed in step S501 (NO in step S501), determining that the recommendation button B21 has not been pressed in step S502 (NO in step S502), and determining that the recommendation button B22 has not been pressed in step S503 (NO in step S503).

In this case, the determination unit 315, in step S504, determines the first block from among multiple blocks associated with corresponding first cooking processes for each of the first cooking processes detected in step S402 according to the washing item reduction rule as described above. The creation unit 316 creates one recommended recipe according to the washing item reduction rule by associating the first blocks determined by the determination unit 315 with the corresponding first cooking processes detected in step S402, and associating the fixed use block stored in the memory 32 in step S403 with each of the second cooking processes detected in step S402.

When determining that the recommendation button B22 has been pressed (YES in step S503) in step S503, the determination unit 315 in step S505 determines the first block from among multiple blocks associated with corresponding first cooking processes for each of the first cooking processes detected in step S402 according to the labor saving rule as described above. The creation unit 316 creates one recommended recipe according to the labor saving rule by associating the first blocks determined by the determination unit 315 with the corresponding first cooking processes detected in step S402, and associating the fixed use block stored in the memory 32 in step S403 with each of the second cooking processes detected in step S402.

When determining that the recommendation button B21 has been pressed (YES in step S502) in step S502, the determination unit 315, in step S506, determines the first block from among multiple blocks associated with corresponding first cooking processes for each of the first cooking processes detected in step S402 according to the time reduction rule as described above. The creation unit 316 creates one recommended recipe according to the time reduction rule by associating the first blocks determined by the determination unit 315 with the corresponding first cooking processes detected in step S402, and associating the fixed use block stored in the memory 32 in step S403 with each of the second cooking processes detected in step S402.

When determining that the recommendation button B23 has been pressed (YES in step S501) in step S501, the determination unit 315 and the creation unit 316, in step S507, create multiple recommended recipes according to the automatic rule. Details of step S507 will be described later.

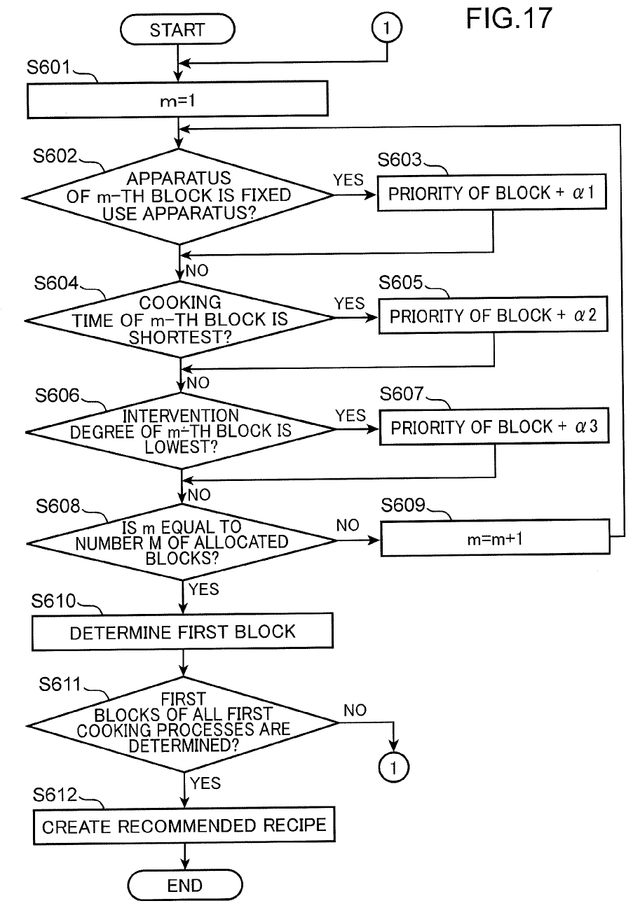

Next, the details of step S507 (FIG. 16) will be described. FIG. 17 is a flowchart illustrating an example of processing of creating a recommended recipe according to the automatic rule.

When step S507 (FIG. 16) is started, the processing of creating a recommended recipe according to the automatic rule illustrated in FIG. 17 is started. The determination unit 315 determines first blocks to be associated with corresponding first cooking processes by performing steps S601 to S610 for all the first cooking processes detected in step S402 (FIG. 15).

Specifically in step S601, the determination unit 315 sets a variable m to 1, and sets a priority of the m-th block to 0, the m-th block being associated with one first cooking process (referred to below as a target first cooking process), in which the first block is not determined, among the first cooking processes detected in step S402.

In steps S602 and S603, the determination unit 315 adds a predetermined first priority α1 to the priority of the first block determined by the washing item reduction rule described above. Specifically in step S602, the determination unit 315 determines whether the apparatus 20 associated with the m-th block associated with the target first cooking process is associated with the fixed use block stored in the memory 32 in step S403 (FIG. 15).

When determining that the apparatus 20 associated with the m-th block is associated with the fixed use block (YES in step S602) in step S602, the determination unit 315 adds the first priority α1 to the priority of the m-th block in step S603 because the m-th block is the first block determined according to the washing item reduction rule described above. When determining that the apparatus 20 associated with the m-th block is not associated with the fixed use block (NO in step S602) in step S602, the determination unit 315 performs step S604.

In steps S604 and S605, the determination unit 315 adds a predetermined second priority α2 to the priority of the first block determined by the time reduction rule described above. Specifically in step S604, the determination unit 315 determines whether the m-th block associated with the target first cooking process has a cooking time that is shortest among cooking times of all blocks associated with the target first cooking process.

When determining that the m-th block has the shortest cooking time (YES in step S604) in step S604, the determination unit 315 adds the second priority α2 to the priority of the m-th block in step S605 because the m-th block is the first block determined by the time reduction rule described above. When determining that the m-th block does not have the shortest cooking time (NO in step S604) in step S604, the determination unit 315 performs step S606.

In steps S606 and S607, the determination unit 315 adds a predetermined third priority α3 to the priority of the first block determined by the labor saving rule described above. Specifically in step S606, the determination unit 315 determines whether the m-th block associated with the target first cooking process has an intervention degree that is the lowest among intervention degrees of all the blocks associated with the target first cooking process.

When determining that the m-th block has the lowest intervention degree (YES in step S606) in step S606, the determination unit 315 adds the third priority α3 to the priority of the m-th block in step S607 because the m-th block is the first block determined by the labor saving rule described above. When determining that the m-th block does not have the lowest intervention degree (NO in step S606) in step S606, the determination unit 315 performs step S608.

When the variable m does not coincide with the number of blocks (referred to below as the number of allocated blocks) M associated with the target first cooking process (NO in step S608) in step S608, the determination unit 315 increments the variable m by 1 in step S609 to repeat the processing in and after step S602.

In subsequent step S610, the determination unit 315 determines a block as the first block to be associated with the target first cooking process from among the multiple blocks associated with the target first cooking process, the block having the highest priority.

When determining first blocks to be associated with all the corresponding first cooking processes detected in step S402 (YES in step S611) in step S611, the determination unit 315 causes the processing to proceed to step S612. In contrast, when determining no first block to be associated with one or more first cooking processes detected in step S402 (NO in step S611) in step S611, the determination unit 315 repeats the processing in and after step S601.

In step S612, the creation unit 316 creates the first recommended recipe according to the automatic rule by associating first blocks determined in step S610 with corresponding first cooking processes in the user recipe R10, and associating the fixed use block of the second cooking process stored in the memory 32 in step S403 (FIG. 15) with a second cooking process other than the first cooking processes in the user recipe R10.

In step S612, the creation unit 316 also creates the second recommended recipe according to the automatic rule by associating blocks having the second highest priority with the corresponding first cooking processes in the user recipe R10, and associating the fixed use block of the second cooking process stored in the memory 32 in step S403 (FIG. 15) with the second cooking process in the user recipe R10.

As described above, the creation unit 316 creates multiple recipes as multiple recommended recipes according to the automatic rule in step S612, the multiple recipes including: blocks associated with the corresponding first cooking processes in the user recipe R10 in descending order of priority; and the fixed use block of the second cooking process stored in the memory 32 in step S403 (FIG. 15) and associated with the second cooking process in the user recipe R10.

The present disclosure can adopt modifications below.

(1) The recipe reference screen W2 (FIG. 5) may include a list box for selecting one rule from among the washing item reduction rule, the time reduction rule, the labor saving rule, and the automatic rule instead of the four recommendation buttons B20 to B23. Then, the generator 314 may determine the first block according to the one rule selected in the list box.

(2) Instead of including the four recommendation buttons B20 to B23 on the recipe reference screen W2 (FIG. 5), a user may store information indicating any one of the washing item reduction rule, the time reduction rule, the labor saving rule, and the automatic rule in the memory 32 by operating the operation unit 34.

In this case, steps S501 to S503 may be omitted in the processing of creating a recommended recipe illustrated in FIG. 16, and the determination unit 315 may perform step S504 when the information indicating one rule stored in the memory 32 indicates the washing item reduction rule. Similarly, when the information indicating one rule stored in the memory 32 indicates the time reduction rule, the labor saving rule, or the automatic rule, the determination unit 315 may perform corresponding one of steps S506, S505, and S507. The determination unit 315 may also perform step S507 when the information indicating one rule is not stored in the memory 32.

(3) The recipe reference screen W2 (FIG. 5) may not include one or more of the three recommendation buttons B20 to B22. When the recipe reference screen W2 includes no recommendation button B20, steps S602 and S603 (FIG. 17) may be omitted. When the recipe reference screen W2 includes no recommendation button B21, steps S604 and S605 (FIG. 17) may be omitted. When the recipe reference screen W2 includes no recommendation button B22, steps S606 and S607 (FIG. 17) in the processing of creating a recommended recipe according to the automatic rule illustrated in FIG. 17 may be omitted.

(4) The processor 31 may be simplified without the determination unit 315 and the creation unit 316.

(5) The application providing server 10 may include a processor with functional units similar to the output unit 311 to the creation unit 316 (FIG. 4) included in the processor 31 of the user terminal 30. In this case, each of the output unit 311 to the creation unit 316 may cause a functional unit similar to itself included in the processor of the application providing server 10 (information processing device) to perform processing via the communication network 90.

The present disclosure enables customizing a recipe easily depending on an apparatus and an instrument possessed by a user, and thus is useful for providing a recipe to various users.

1. An information processing method comprising:
by a computer,
acquiring information indicating a first recipe including multiple cooking processes and multiple blocks associated with the corresponding multiple cooking processes, the multiple blocks including first information indicating at least one of an apparatus and an instrument used in the multiple cooking processes;
acquiring second information indicating one or more apparatuses and instruments possessed by a user and information indicating operation states of the one or more apparatuses and instruments indicated by the second information;
generating a second recipe by deleting, from the first recipe, a block including one or more apparatuses and instruments that are included in the first information and are not included in the second information, and a block including one or more apparatuses and instruments having an operation state indicating being in operation; and
outputting information indicating the second recipe to be displayed on a display.

2. The information processing method according to claim 1, comprising:
determining a first block from among multiple blocks associated with the first cooking process, according to one or more rules, when a first cooking process associated with multiple blocks is detected from the second recipe;
creating one or more third recipes according to the one or more rules by associating the first block with the first cooking process in the second recipe; and
outputting information indicating the one or more third recipes to be displayed on the display.

3. The information processing method according to claim 2, wherein
the one or more rules include a first rule, and
the first rule is defined to determine a block as the first block from among the multiple blocks associated with the first cooking process when a second cooking process associated with only one block is detected from the second recipe, the block including an apparatus included in the one block.

4. The information processing method according to claim 2, wherein
the respective blocks further include cooking times required for a cooking process,
the one or more rules include a second rule, and
the second rule is defined to determine a block as the first block from among the multiple blocks associated with the first cooking process, the block including a shortest time among the cooking times.

5. The information processing method according to claim 2, wherein
the respective blocks further include intervention degrees as degrees of involvement of a person in each cooking process,
the one or more rules include a third rule, and
the third rule is defined to determine a block as the first block from among the multiple blocks associated with the first cooking process, the block including a lowest degree among the intervention degrees.

6. The information processing method according to claim 2, wherein
the one or more rules are multiple rules,
input of one rule selected from the multiple rules by a user is received, and
one third recipe according to the one rule is created using the first block determined according to the one rule.

7. An information processing device comprising:
a first acquisition unit that acquires information indicating a first recipe including multiple cooking processes and multiple blocks associated with the corresponding multiple cooking processes, the multiple blocks including first information indicating at least one of an apparatus and an instrument used in the multiple cooking processes;
a second acquisition unit that acquires second information indicating one or more apparatuses and instruments possessed by a user and information indicating operation states of the one or more apparatuses and instruments indicated by the second information;
a generator that generates a second recipe by deleting, from the first recipe, a block including one or more apparatuses and instruments that are included in the first information and are not included in the second information, and a block including one or more apparatuses and instruments having an operation state indicating being in operation; and
an output unit that outputs information indicating the second recipe to be displayed on a display.

8. A non-transitory computer readable storage medium storing a program that causes a computer to function, the computer functioning as:
a first acquisition unit that acquires information indicating a first recipe including multiple cooking processes and multiple blocks associated with the corresponding multiple cooking processes, the multiple blocks including first information indicating at least one of an apparatus and an instrument used in the multiple cooking processes;
a second acquisition unit that acquires second information indicating one or more apparatuses and instruments possessed by a user and information indicating operation states of the one or more apparatuses and instruments indicated by the second information;
a generator that generates a second recipe by deleting, from the first recipe, a block including one or more apparatuses and instruments that are included in the first information and are not included in the second information, and a block including one or more apparatuses and instruments having an operation state indicating being in operation; and
an output unit that outputs information indicating the second recipe to be displayed on a display.
